(19) United States
(12) Patent Application Publication
(10) Pub. No.: US 2005/0021641 A1
(43) Pub. Date: Jan. 27, 2005

(54) Program, method, apparatus and recording medium for supporting inquiries from server to operator

(75) Inventor: Toshitaka Hasegawa, Aichi (JP)

Correspondence Address: STAAS & HALSEY LLP, SUITE 700, 1201 NEW YORK AVENUE, N.W., WASHINGTON, DC, 20005, US

(73) Assignee: Fujitsu Limited, Kawasaki (JP)

(21) Appl. No.: 10/793,095

(22) Filed: Mar. 5, 2004

(30) Foreign Application Priority Data
Mar. 11, 2003 (JP) 2003-065230

(51) Int. Cl. G06F 15/16

(52) U.S. Cl. 709/206

(57) ABSTRACT

A program that helps a server process receive responses from an operator. A computer server stores ready replies in a ready reply memory when receiving the ready replies from a client over a network, the ready replies each including two elements a reply message for specifying an inquiry and reply data to be used as a response. When the service process issues an inquiry, the server compares the message of the inquiry with the reply message of a ready reply being stored in the ready reply memory. When the messages match, the computer server gives the reply data of the ready reply to the service process as a response to the inquiry.

### BACKGROUND OF THE INVENTION

1. Field of the Invention

The present invention relates to a program, method, apparatus, and recording medium for helping service processes in a server to receive information from an operator. More particularly, the present invention pertains a program, method, apparatus and recording medium that support advance reply registration for inquiries to be issued from a service process.

2. Description of the Related Art

Client-server systems are widely used today. Server programs running on a server computer (or simply “server”) provide various services to a plurality of client computers (or simply “clients”) in response to their demands. Generally, server programs are designed to offer a requested service according to a predetermined sequence of processing steps. Servers are supposed to continue their services, performing most tasks without operator intervention.

The exception is that server programs sometimes need to be reconfigured, even in the middle of operation, to ensure the reliability of service. For example, a server program may encounter such a situation where it needs an instruction from the system operator before proceeding to the next stage of service. Based on the operation instruction, the server program decides which way to go. In this situation, the ongoing process on the server has to actively interact with the operator, displaying messages and prompting the operator to answer. The interaction between a server and operator requires a set of user interface functions, but it is generally impractical to install such modules in each server program. Conventional servers therefore provide a mechanism for a server program to communicate with the operator, which is a macro instruction known as “write-to-operator with reply (WTOR).” For mode details about this WTOR mechanism, refer to, for example, “OSIV/MSP System Programming Manual (Task Management) for AFII V10 OS IV/MSP,” Forth Edition, Fujitsu LIMITED, June, 2000 (original in Japanese). Particularly relevant are: Chapter 14, “Operator-Program Communications” and Section 14.1.5, “Functions of WTOR macro instruction.”

One drawback of the conventional method using a WTOR macro is that the operator is likely to make a mistake in entering an answer. That is, server programs expect the operator to enter a character string in a predefine format that they require, which, however, can easily be violated due to the respondent's simple typing errors.

Therefore, the inventors of this invention invented an inquiry support program that prevents an operator from returning a wrong reply in response to an inquiry message from a server (Japanese Patent Application No. 2002-344908). In this invention, a server process which is a part of a computer system issues an inquiry to the operator when it needs information from the operator. An inquiry handler (which executes the inquiry support program) receives and saves the inquiry. After that, in response to an inquiry delivery request from a client, the inquiry handler retrieves and sends the inquiry to the client. The operator sends a reply to the inquiry from the client. Upon receipt of the reply, the inquiry handler passes this to the service process. With the reply received, the service process resumes the service process that has been suspended.

The above reference discloses log transmission, transmission of possible answers, timeout handling, and command execution in response to reply in detail. This inquiry support technique enables an operator to easily answer an inquiry from a server. This technique, however, requires operator inputs to respond an inquiry from the server. Therefore, when the operator is absent, the service process stops due to no answer from the operator.

In general, at least one operator monitors inquiries from the server so as not to delay a reply. This situation, however, deteriorates working efficiency because the operator cannot be away from the client. Even in a case where the operator knows that the service process starts at a fixed time and the process issues an inquiry, he/she has to wait the inquiry to be issued. In addition, if he/she takes time to answer an inquiry even he/she is at the client, the computer system delays the service, resulting in deteriorated efficiency.

Such a case is now considered that a service process starts to read input data from a file placed in a specified directory. In general, the service process displays an inquiry message “Move input data to the specified directory.” The operator confirms the message, moves the input data to the specified directory, and clicks a “Done” check box. Then the service process is able to continue the process. This scheme has a problem that clicking the Done check box does not take effect before the inquiry message is displayed, resulting in delaying the execution time of service process.

### SUMMARY OF THE INVENTION

In view of the foregoing, the present invention intends to provide a program, method, apparatus and recording medium that enable a service process to automatically obtain a reply out of previously registered replies, in response to an issued inquiry.

To achieve the above object, there provided a program to help a service process receive responses. This program causes a computer system to perform a process comprising the steps of: storing a ready reply in a ready reply memory when receiving the ready reply from a client over a network, the ready reply including two elements: a reply message for specifying an inquiry and reply data to be used as a response; comparing the message of an inquiry with the reply message of the ready reply being stored in the ready reply memory when the service process issues the inquiry; and passing the reply data to the service process when a comparison result shows that the message and the reply message match.

Further, to achieve the above object, there provided a method for helping a service process receive responses. This method comprises the steps of: storing a ready reply in a ready reply memory when a client sends the ready reply over a network, the ready reply including two elements: a reply message for specifying an inquiry and reply data to be used as a response; comparing the message of an inquiry with the reply message of the ready reply being stored in the ready reply memory when the service process issues the inquiry; and passing the reply data to the service process when a comparison result shows that the message and the reply message match.

Still further, to achieve the above object, there provided an apparatus for helping a service process receive responses. This apparatus comprises: a storing unit for storing a ready reply in a ready reply memory when receiving the ready reply from a client over a network, the ready reply including two elements: a reply message for specifying an inquiry and reply data to be used as a response; a comparison unit for comparing the message of an inquiry with the reply message of the ready reply being stored in the ready reply memory when the service process issues the inquiry; and a notification unit for passing the reply data to the service process when a comparison result shows that the message and the reply message match.

The above and other objects, features and advantages of the present invention will become apparent from the following description when taken in conjunction with the accompanying drawings which illustrate preferred embodiments of the present invention by way of example.

### BRIEF DESCRIPTION OF THE DRAWINGS

FIG. 1 shows the concept of the present invention.

FIG. 2 shows a network system according to the present embodiment.

FIG. 3 shows a computer hardware platform according to this embodiment.

FIG. 4 shows a functional structure of a server.

FIG. 5 is a block diagram showing functions of a ready reply handler.

FIG. 6 shows a reply entry screen.

FIG. 7 is a sequence diagram showing how to register a ready reply.

FIG. 8 shows a data structure of a ready reply memory.

FIG. 9 shows ready replies.

FIG. 10 is a sequence diagram showing a procedure of a reply process performed by the ready reply handler.

FIG. 11 shows a reply selection screen.

FIG. 12 shows a reply entry screen following the reply selection screen.

FIG. 13 is a sequence diagram of reply registration by using a log of past replies.

FIG. 14 shows a reply confirmation screen.

FIG. 15 is a sequence diagram showing how to change a ready reply.

### DESCRIPTION OF THE PREFERRED EMBODIMENTS

Preferred embodiments of the present invention will be described below with reference to the accompanying drawings. The following description will first outline the invention and then give a more specific explanation for how the invention will be implemented.

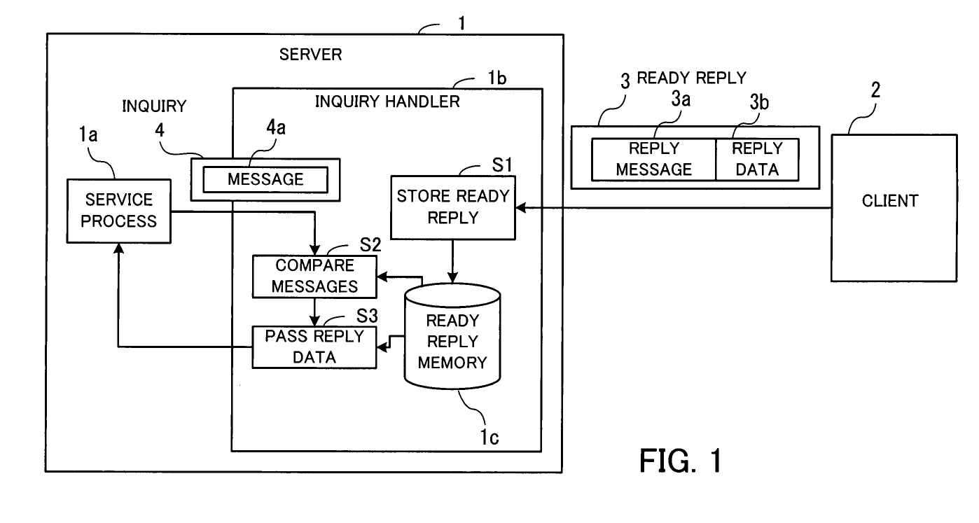

FIG. 1 shows the concept of the present invention. This invention enables an inquiry handler 1b to automatically respond an inquiry 4 from a service process 1a of a server 1, by storing ready replies 3 sent from a client 2 to the server 1.

The server 1 is composed of the service process 1a and the inquiry handler 1b. The service process 1a executes its service under a server process and outputs the inquiry 4 when it requires instructions from an operator. The inquiry handler 1b has a ready reply memory 1c for storing the ready replies 3 and executes the following processes.

The inquiry handler 1b receives from the client 2 over a network a ready reply 3 and stores it in the ready reply memory 1c, the ready reply 3 including two elements: a reply message 3a for specifying an inquiry and reply data 3b to be used as a response (step S1). In a case where the ready reply 3 includes information on a message comparison method, and a possible number of times and valid period for the ready reply 3, this information is stored in the ready reply memory 1c as well. The possible number of times indicates how many times the ready reply 3 can be used for a response. The valid period indicates when the ready reply 3 can be used for a response.

When the service process 1a issues an inquiry 4, the inquiry handler 1b compares the message 4a included in the inquiry 4 with the reply message 3a of a ready reply 3 being stored in the ready reply memory 1c (step S2), under the comparison method. The comparison method is full match, header match, part match, or the like. When the comparison method is full match, the comparison result shows match only when the reply message 3a of the ready reply 3 and the message 4a of the inquiry 4 are completely the same. When the comparison method is header match, the comparison result shows match only when the headers of the reply message 3a of the ready rely 3 and the message 4a of the inquiry 4 are the same. When the comparison method is part match, the comparison result shows match only when the message 4a of the inquiry 4 includes the reply message 3a of the ready reply 3.

When the comparison result shows match, the inquiry handler 1b gives the reply data 3b of the ready reply 3 to the service process 1a as a response to the inquiry 4 (step S3). It should be noted that when the ready reply 3 specifies a possible number of times or a valid time, the reply data can be sent only when these conditions are satisfied.

Therefore, when the service process 1a issues an inquiry 4 including a message 4a matching a reply message 3a, the reply data 3b corresponding to the reply message 3a is given to the service process 1a as a response. As a result, an operator of the client 2 is able to register a reply to an expectable inquiry 4 in advance before the inquiry 4 is issued, thus improving working efficiency of the operator. In addition, the service process 1a does not need to wait the operator to make a reply to the inquiry 4, thus improving the processing efficiency.

Now, the preferred embodiment of the present invention will be described in detail.

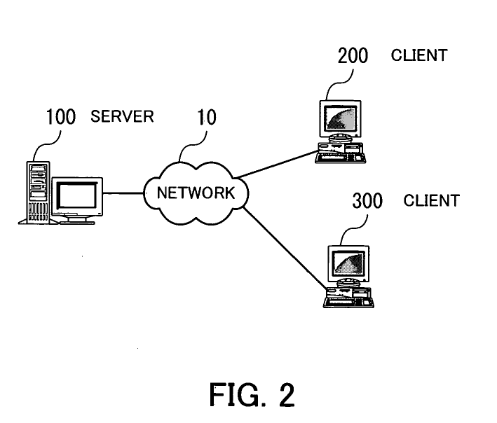

FIG. 2 shows an example of a network system according to the present embodiment. A server 100 is connected to a plurality of clients 200 and 300 over a network 10.

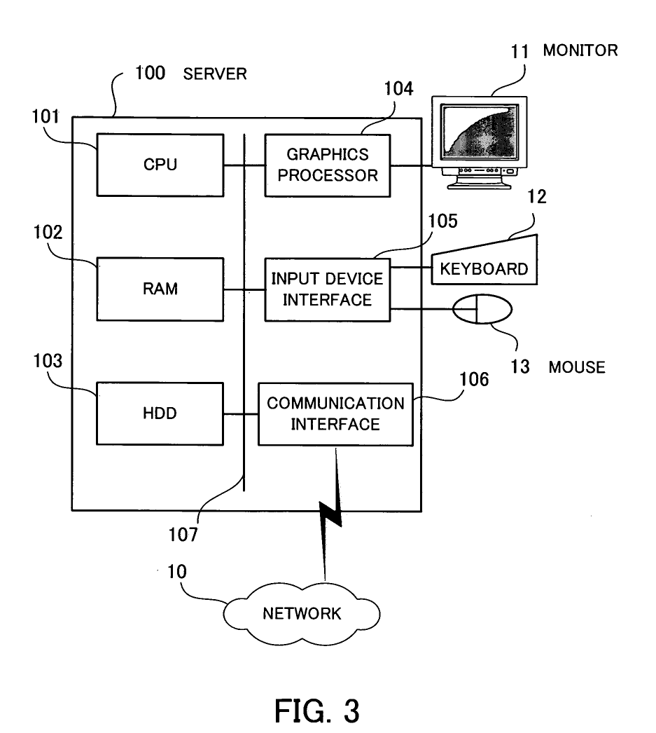

FIG. 3 shows an example of a computer hardware platform on which the present invention is implemented. The illustrated server 100 has the following circuit elements: a central processing unit (CPU) 101; a random access memory (RAM) 102; a hard disk drive (HDD) 103; a graphics processor 104; an input device interface 105; and a communication interface 106. The CPU 101 controls the entire system of the server 100, interacting with other elements via a common bus 107. The RAM 102 temporarily stores the whole or part of operating system (OS) programs and application programs that the CPU 101 executes, in addition to other various data objects manipulated at runtime. The HDD 103 stores program and data files of the operating system and various applications.

The graphics processor 104 produces video images in accordance with drawing commands from the CPU 101 and displays them on the screen of an external monitor 11 coupled thereto. The input device interface 105 is used to receive signals from external input devices such as a keyboard 12 and a mouse 13. Input signals are supplied to the CPU 101 via the bus 107. The communication interface 106 is connected to the network 10, allowing the CPU 101 to exchange data with other computers (not shown) over the network 10.

The functions of the present invention can be embodied with the above-described hardware structure. While FIG. 3 illustrates a platform for the server 100, the same or similar hardware structure may also be applied to the clients 200 and 300.

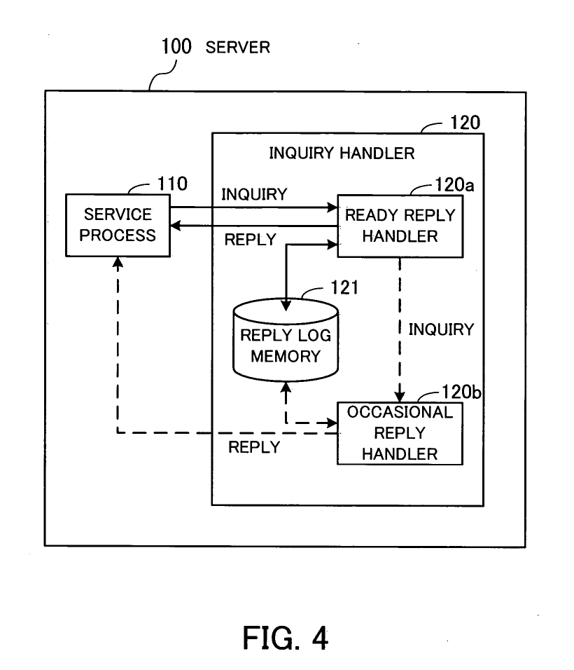

FIG. 4 shows the functional structure of the server 100. The service process 110 is actually a collection of one or more processes (tasks) constituting a server program executed by the server 100 (server computer). In normal operation, the service process 110 provides services in response to requests from the clients 200 and 300. When the service process 110 needs operator intervention, it suspends the current process and issues an inquiry with a message to be displayed on a client screen. When receiving a reply to this inquiry, the service process 110 resumes the pending process with an appropriate procedure according to the reply. The message is, for example, “Who is the person in charge?” or “Select the place for the business trip.”

The inquiry handler 120 helps the service process 110 obtain a reply from the operator. The inquiry handler 120 is roughly composed of a reply log memory 121, a ready reply handler 120a, and an occasional reply handler 120b. The reply log memory 121 stores a log of inquiries and corresponding replies.

The ready reply handler 120a communicates with the clients 200 and 300 and manages ready replies to expectable inquiries. Specifically, when the clients 200 and 300 makes a past reply request, the ready reply handler 120a obtains a log of past replies from the reply log memory 121 and sends it back. When receiving ready replies from the clients 200 and 300, the ready reply handler 120a keeps them. When the service process 110 issues an inquiry, the ready reply handler 120a returns appropriate reply data to the service process 110 and stores the inquiry and the reply data in the reply log memory 121. When the ready reply handler 120a does not have appropriate reply data, it passes the inquiry to the occasional reply handler 120b.

The occasional reply handler 120b communicates with the clients 200 and 300 to obtain replies in real time. Specifically, when receiving an inquiry, the occasional reply handler 120b sends it together with a log of past replies from the reply log memory 121 to the client 200, 300. When receiving a reply from the client 200, 300, the occasional reply handler 120b returns it to the service process 110 and stores it in the reply log memory 121. The functions of the occasional reply handler 120b are disclosed in Japanese Patent Application No. 2002-344908 in detail.

The processing mechanism of this invention will be now described.

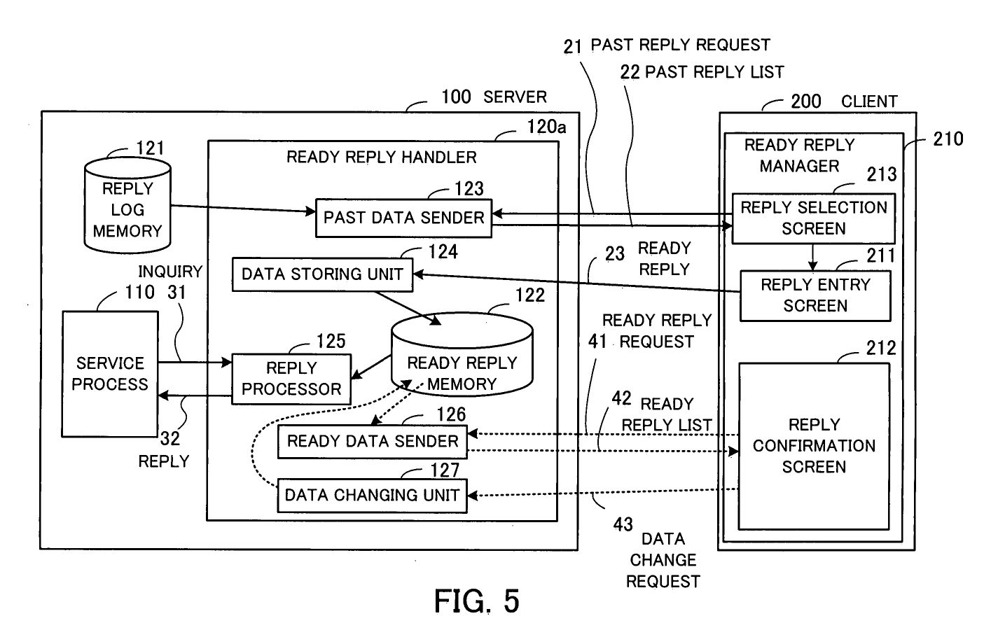

FIG. 5 is a block diagram showing the functions of the ready reply handler. Note that FIG. 5 shows relations between the ready reply handler 120a in the server 100 and the ready reply manager 210 in the client 200, assuming that an operator uses the client 200 to register a ready reply. The ready reply manager 210 is a user interface for transmitting ready replies to the server 100 according to operator's operations.

The ready reply handler 120a is composed of a ready reply memory 122, a past data sender 123, a data storing unit 124, a reply processor 125, a ready data sender 126, and a data changing unit 127.

The ready reply memory 122 is a storage unit for storing ready replies sent from the client 200. For example, this memory 122 is a memory region of the HDD 103 shown in FIG. 3.

The past data sender 123 sends a past reply list in response to a past reply request 21 from the client 200. Specifically, when the past data sender 123 receives the past reply request 21 from the client 200, it extracts a log of past replies each composed of a past inquiry and a corresponding reply from the reply log memory 121. Then the past data sender 123 creates a past reply list 22 based on the inquiries and replies included in the obtained log and sends it to the client 200. The past reply list 22 may be a list of reply data used in the past as responses to the service process 110, or a list of reply alternatives issued together with an inquiry from the service process 110.

Based on the past reply list 22 from the past data sender 123, the ready reply manager 210 of the client 200 displays a reply selection screen 213 listing inquiries and their replies. The operator selects a desired inquiry. A combination of the selected inquiry and its reply data is displayed on a reply entry screen 211. After the operator enters additional information on this screen 211, the ready reply manager 210 sends these data to the server 100 as a ready reply 23. In this way, the operator can specify a desired inquiry to be responded and sets reply data to the inquiry easily and surely. Alternatively, the operator can enter necessary information on the reply entry screen 211 as the ready reply 23.

The data storing unit 124 receives as the ready reply 23 data set by the operator on the reply entry screen 211 displayed on the client 220, and stores the ready reply 23 in the ready reply memory 122. Note that, when the ready reply 23 includes a message comparison method, a possible number of times and a valid period, this information is stored in the ready reply memory 122 as well.

The possible number of times indicates how many times a reply based on the ready reply 23 can be sent to the service process 110. If the possible number of times is not specified, the reply based on the ready reply 23 can be sent repeatedly.

The valid period indicates when a reply based on the ready reply 23 can be sent to the service process 110. For example, when the service process 110 has a usual operation time, a ready reply 23 to an inquiry issued during this operation time can be registered with the operation time set as the valid period.

When neither the possible number of times nor the valid period is specified, the reply based on the ready reply 23 can be sent for corresponding inquiries until the ready reply 23 is deleted.

The reply processor 125 makes a reply based on a ready reply 23 being stored in the ready reply memory 122, in response to an inquiry output from the service process 110. Specifically, when the service process 110 issues an inquiry 31, the reply processor 125 compares the inquiry 31 with the reply message of a ready reply 23 being stored in the ready reply memory 122. The comparison result shows match, the reply processor 125 passes the corresponding reply data to the service process 110.

Assume that a ready reply 23 being stored in the ready reply memory 122 includes a possible number of times. When the service process 110 issues an inquiry 31, the reply processor 125 compares the inquiry 31 with the reply message of the ready reply 23 being stored in the ready reply memory 122. When the comparison result shows match and the number of times indicating how many times the ready reply 23 was used for a response does not reach the possible number of times, the reply processor 125 sends a reply based on the ready reply 23 to the service process 110.

Assume that a ready reply 23 being stored in the ready reply memory 122 includes a valid period. When the service process 110 issues an inquiry 31, the reply processor 125 compares the inquiry 31 with the reply message of the ready reply 23 being stored in the ready reply memory 122. When the comparison result shows match and the time when the inquiry was issued is within the valid period, the reply processor 125 sends a reply based on the ready reply 23 to the service process 110.

The ready data sender 126 sends a ready reply list 42 in response to a ready reply request 41 from the ready reply manager 210 of the client 200. Specifically, when the operator enters a command to check ready replies on the reply confirmation screen 212 of the client 200, the ready reply manager 210 sends the ready reply request 41 to the server 100. In the server 100, the ready data sender 126 extracts ready replies 23 from the ready reply memory 122 in response to the ready reply request 41. Then the ready data sender 126 sends the obtained ready replies as a ready reply list 42. The ready reply manager 210 displays this list 42 on the reply confirmation screen 212.

The operator can change or delete a ready reply on this screen 212. The ready reply manager 210 sends a data change request 43 to the server 100 according to operator's operations.

In response to the data change request 43 indicating deletion or change of a ready reply, the data changing unit 127 changes or deletes the corresponding ready reply being stored in the ready reply memory 122.

In the above system, a ready reply to an inquiry can be registered. Now, ready reply registration will be described in detail.

The operator uses the client 200 to register reply data to an inquiry. The operator makes the ready reply manager 210 of the client 200 display the reply entry screen 211.

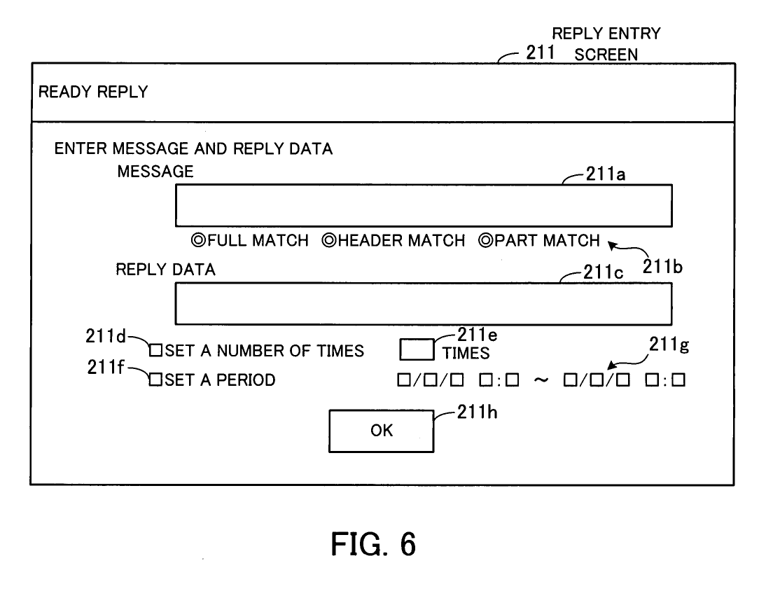

FIG. 6 shows an example of the reply entry screen. This reply entry screen 211 includes a message box 211a, comparison method selection buttons 211b, a reply data box 211c, a possible-number-of-times check box 211d, a possible-number-of-times box 211e, a valid-period check box 211f, a valid-period box 211g and an OK button 211h.

The message box 211a is a text box for entering a reply message for specifying an inquiry. This message is compared with the message of an inquiry issued, in order to specify an inquiry corresponding to the ready reply.

The comparison method selection buttons 211b are selection buttons to specify a comparison method for comparing a message entered in the message box 211a with an inquiry issued from the service process 110. In this example in FIG. 6, one out of “full match”, “header match”, and “part match” is selected.

When full match is specified, the comparison result shows match only when a message entered in the message box 211a is all the same as the message of an inquiry issued by the service process 110.

When header match is specified, the comparison result shows match only when the header of the message of an inquiry issued by the service process 110 is the same as a message entered in the message box 211a. A case where a message can be identified at the header is for example, the one where the header of the message of an inquiry has a message ID. In this case, the operator enters the message ID in the message box 221a and selects “header match” with the comparison method selection button 211b, thereby specifying the inquiry. In this way, an inquiry can be easily specified for a ready reply.

When part match is specified, the comparison result shows match only when the message of an inquiry issued by the service process 110 includes a message entered in the message box 211a. When the message of an inquiry has a date and time which are variable elements, the operator enters a character string other than the date and time and selects “part match” by the comparison method selection button 211b. In this way, an inquiry can be easily specified for a ready reply.

The reply data box 211c is a text box for entering reply data to be used as a response to an inquiry.

The possible-number-of-times check box 211d is a check box for setting a possible number of times for a ready reply 23. By checking this box 211d, the possible-number-of-times box 211e becomes effective.

The possible-number-of-times box 211e is a text box to set a possible number of times for a ready reply 23. When a possible number of times is set in this box 211e, replies can be made automatically in response to inquiries corresponding to the ready reply within the possible number of times.

The valid period check box 211f is a check box for setting a valid period for the ready reply 23. By checking this box 211f, the valid period box 211g becomes effective.

The valid period box 211g is a text box to set a valid period for a ready reply 23. By setting a valid period in this box 211g, replies can be made automatically in response to inquiries corresponding to the ready reply within the valid period. When a time is over the valid period, the ready reply 23 cannot be used.

The OK button 211h is a button to fix the entered data on the reply entry screen 211. By pressing the OK button 211h, the ready reply manager 210 creates a ready reply 23 based on the entered data on the reply entry screen 211 and sends it to the server 100. Then the reply entry screen 211 disappears.

As described above, the operator can send a ready reply 23 to the server 100 by entering data on such a reply entry screen 211. In the server 100, the data storing unit 124 stores the ready reply 23 in the ready reply memory 122.

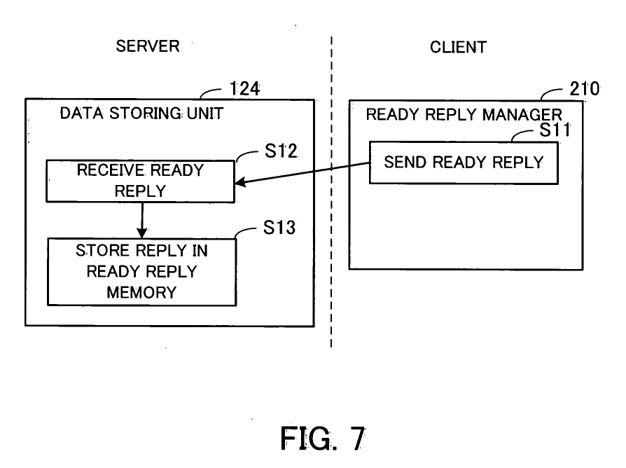

FIG. 7 shows a ready reply registration process. This process will be described following step numbers of FIG. 7. After the operator enters information on the reply entry screen 211 of the client 200 and presses the OK button 211h, this process starts.

[Step S11] The ready reply manager 210 of the client 200 creates a ready reply 23 based on information entered on the reply entry screen 211 and sends it to the inquiry handler 120 of the server 100.

[Step S12] The data storing unit 124 of the server 100 receives the ready reply 23 from the client 200.

[Step S13] The data storing unit 124 stores the received ready reply 23 in the ready reply memory 122.

In this way the ready reply 23 is stored in the ready reply memory 122.

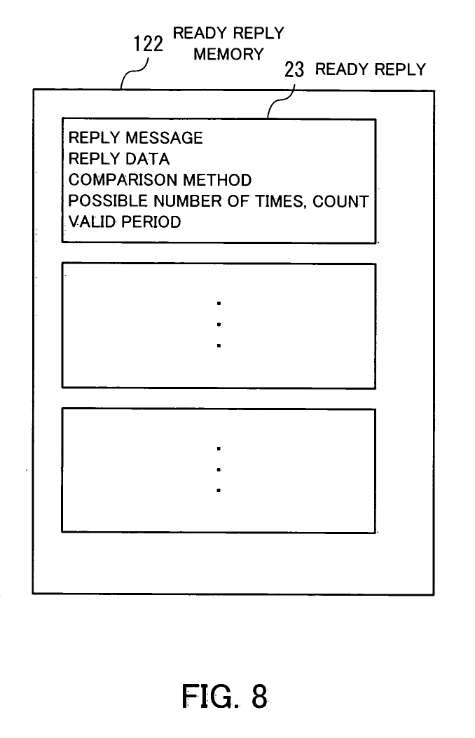

FIG. 8 shows a data structure of the ready reply memory 122. The ready reply memory 122 stores the same number of ready replies 23 as the messages of inquiries to which replies are registered. Each ready reply 23 includes a reply message, reply data, a comparison method, a possible number of times, a count, and a valid period. These contents correspond to data entered on the reply entry screen 211 shown in FIG. 6. The comparison method is selected out of full, header and part. When the possible number of times is not specified, “0” is stored. The count indicates how many times the reply data was used for reply. When the valid period is not specified, “@” is stored.

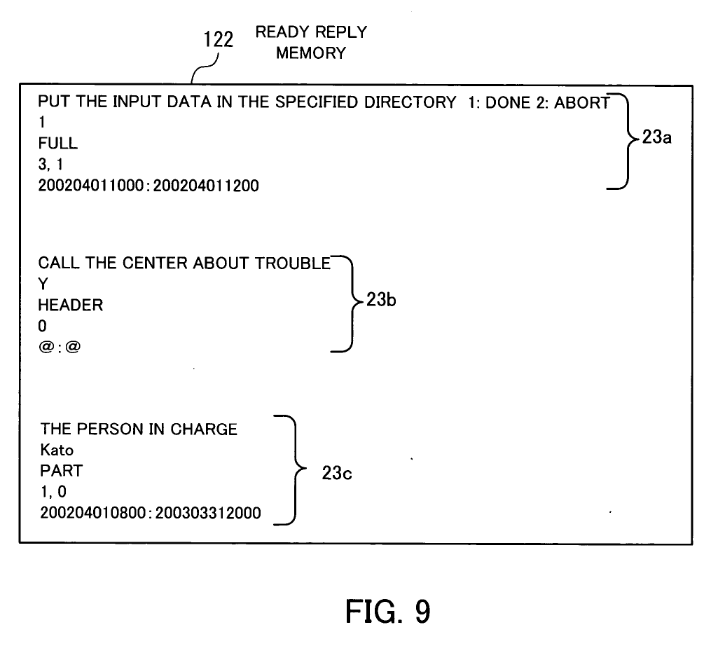

FIG. 9 shows specific examples of ready replies. In a ready reply 23a of FIG. 9, a response “1” is set to a reply message “Put the input data in the specified directory. 1:Done 2:Abort”. Messages are compared under full match. The possible number of times is three times, the count is once, and the valid period is from 10:00 on April 1 in 2002 to 12:00 on April 1 in 2002.

In a ready reply 23b, a response “Y” is set to a reply message “Call the center about trouble”. Messages are compared under header match. Neither possible number of times nor valid period is specified.

In a ready reply 23c, “Kato” is set to a reply message “The person in charge”. Messages are compared under part match. The possible number of times is once, the count is zero, and the valid period is from 8:00 on April 1 in 2002 to 20:00 on March 31 in 2003.

Such ready replies 23 are stored in the ready reply memory 122. When the service process 100 issues an inquiry including a reply message of a ready reply 23, the ready reply handler 120a makes a response automatically.

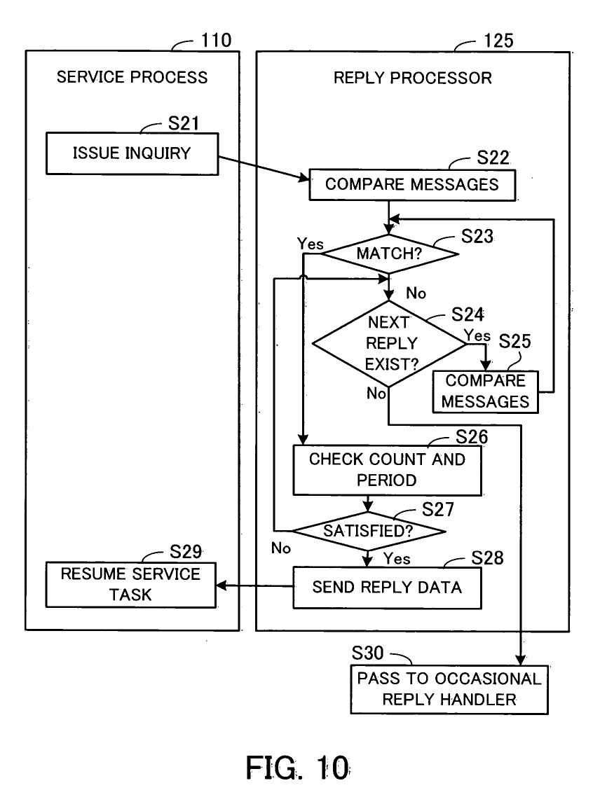

FIG. 10 is a sequence diagram showing a response process to an inquiry by the ready reply handler 120a. This process of FIG. 10 will be described following step numbers.

[Step S21] When the service process 110 needs an instruction from an operator while executing processes based on the server program, it issues an inquiry with an application program interface (API) predefined for exchanging data between the service process 110 and the reply processor 125.

[Step S22] The reply processor 125 of the ready reply handler 120a compares the message of the inquiry with the reply message (contents entered in the message box 211a of the reply entry screen 211) of the first ready reply 23 being stored in the ready reply memory 122.

[Step S23] The reply processor 125 determines if the messages match. This comparison is made under the comparison method included in the ready reply 23 (contents entered in the comparison method box 211b of the reply entry screen 211). The process goes on to step S26 when the messages match. The process goes on to step S24 when the messages do not match.

[Step S24] The reply processor 125 searches the ready reply memory 122 for the next ready reply 23. The process goes on to step S25 when the next ready reply 23 exists. The process goes on to step S30 when the next ready reply 23 does not exist.

[Step S25] The reply processor 125 compares the message of the inquiry with the message of the next ready reply 23. Then the process goes on to step S23.

[Step S26] The reply processor 125 checks the possible number of times and/or the valid period of the ready reply 23 having the matching message. When the possible number of times is specified, the reply processor 125 compares this possible number of times with the count of the ready reply 23. In addition, when a valid period is specified, there ply processor 125 compares the valid period with the time when the inquiry was issued.

[Step S27] The reply processor 125 determines if the ready reply 23 satisfies the possible number of times or the valid period. When the possible number of times is specified and the count has reached the possible number of times, it is determined that the ready reply 23 does not satisfy the conditions. When the possible number of times is specified and the count has not reached the possible number of times, it is determined that the ready reply 23 satisfies the conditions. When the valid period is specified and the time when the inquiry was issued is not within the valid period, it is determined that the ready reply 23 does not satisfy the conditions. When the valid period is specified and the time when the inquiry was issued is within the valid period, it is determined that the ready reply 23 satisfies the conditions.

In a case of unsatisfaction, the process goes on to step S24. In a case of satisfaction, the process goes on to step S28. In a case where neither the possible number of times nor the valid period is specified, the process goes on to step S28.

[Step S28] The reply processor 125 sends the reply data (contents entered in the reply data box 211c of the reply entry screen 211) of the ready reply 23 compared, as recovery information to the inquiry issued by the service process 110. Then the reply processor 125 finishes this process.

[Step S29] The service process 110 receives the reply data as the recovery information to the inquiry and resumes its tasks based on the data.

[StepS30] When the ready reply memory 122 does not include a ready reply 23 which matches the message of the inquiry and satisfies the possible number of times or the valid period, this response process ends and the occasional reply handler 120b starts its process.

In this way, since reply data to an inquiry is registered in advance, a reply can be made automatically without operator's operation when an inquiry is issued. As a result, the service process 110 can avoid a delay in its process caused by waiting for a reply to an inquiry, resulting in improving processing efficiency.

Further, the operator can select reply data from a log of past replies. Specifically, when the operator uses the client 200 to instruct the ready reply manager 210 to obtain the log of past replies, the ready reply manager 210 outputs a past reply request 21 to the past data sender 123 of the server 100. The past data sender 123 obtains the log of past replies from the reply log memory 121 and sends it as a past reply list 22 to the ready reply manager 210. The ready reply manager 210 receives this list 22 and displays a reply selection screen to register a ready reply by using the messages which were created and used in the past.

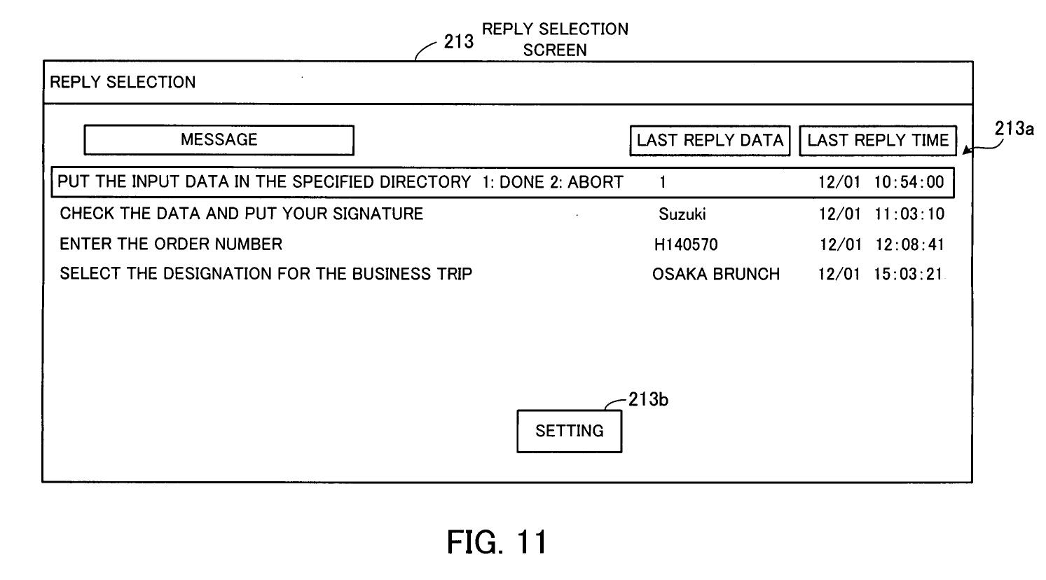

FIG. 11 shows an example of the reply selection screen. This screen 213 includes a past reply list 213a and a setting button 213b. The past reply list 213a shows messages, last reply data and time. The message is of an inquiry issued by the service process 110. The last reply data is last reply data for the corresponding message. The last reply time is a last reply time for the corresponding message. In this way, the reply selection screen 213 shows message which was created and used in the past in order as an inquiry message, last reply data, and last reply time.

In this example of FIG. 11, there are four selectable replies. In the order of a message, last reply data and a last reply time, the first reply indicates “Put the input data in the specified directory. 1: Done 2: Abort”, “1”, and “10:54:00 on December 1”. By using alternatives in the message, the operator can simply select one of the alternatives as reply data. Similarly, the second indicates “Check the data and put your signature”, “Suzuki”, “11:03:10 on December 1”. The third indicates “Enter the order number”, “H140570”, and “12:08:41 on December 1”. The fourth indicates “Select the destination for the business trip”, “Osaka brunch”, “15:03:21 on December 1”.

The operator can select one reply as a ready reply 23. In this example of FIG. 11, the operator is selecting the first reply.

The setting button 213b is a button to fix the selected reply as a ready reply 23. By clicking the setting button 213b, the reply entry screen 211 appears.

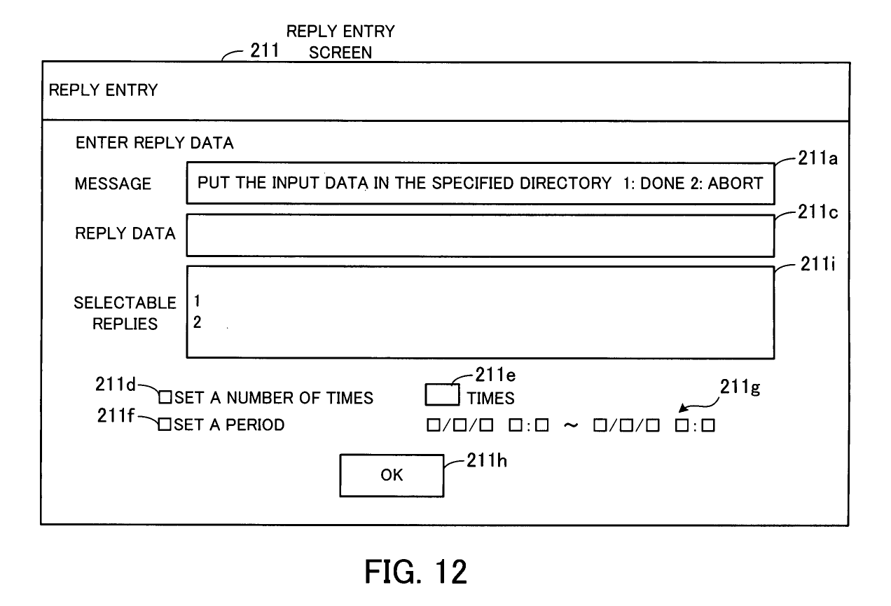

FIG. 12 shows an example of the reply entry screen following the reply selection screen. As shown in FIG. 12, this reply entry screen 211 following the reply selection screen 213 shows the data of a reply selected on the reply selection screen 213. Specifically, the message of the selected reply is set in the message box 211a of the reply entry screen 211.

For a case where the message has alternatives, the reply entry screen 211 has a selectable reply box 211i. This selectable reply box 211i shows all the alternatives. In FIG. 12, “1” and “2” are displayed. When the operator selects desired reply data on the selectable reply box 211i, the selected reply data is set in the reply data box 211c.

When the operator sets a possible number of times and a valid period and clicks the OK button 211h on the reply entry screen 211, the ready reply manager 210 creates and sends a ready reply 23 based on the selected reply to the data storing unit 124 of the server 100.

In this way, a message selected on the reply selection screen 213 is displayed on the reply entry screen 211 and reply selections (alternatives) for the selected message are displayed aswell. Since the reply data can be entered by simply selecting one of the alternatives, the reply data can be set easily.

When the message of an inquiry has no alternatives as reply data, the reply data of past replies to the same message are set in the selectable reply box 211i of the reply entry screen 211. In a case where the reply data is displayed in the selectable reply box 211i, the operator can select one reply data. In a case where reply data is not displayed, the operator directly enters data in the reply data box 211c.

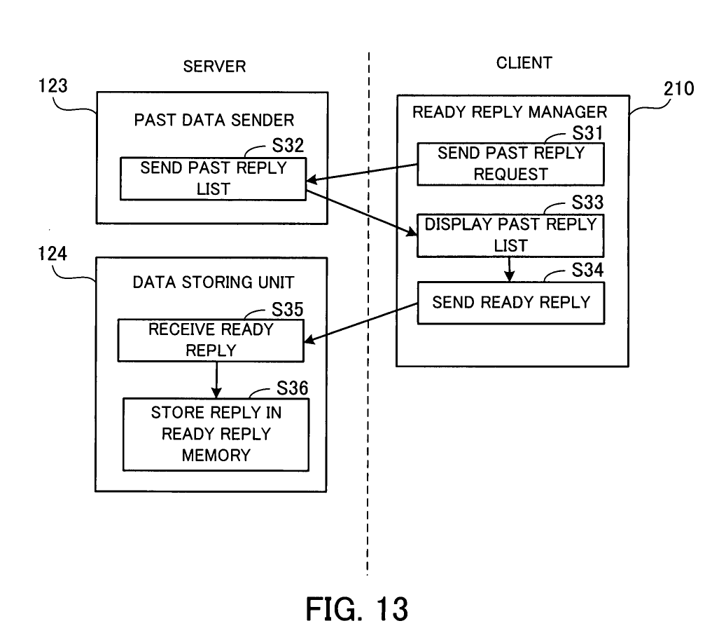

FIG. 13 is a sequence diagram showing ready reply registration by using a log of past replies. The process of FIG. 13 will be described following step numbers.

[Step S31] The ready reply manager 210 sends a past reply request 21 to the inquiry handler 120.

[Step S32] The past data sender 123 extracts and sends past replies from the reply log memory 121 to the client 200 as a past reply list 22.

[Step S33] The ready reply manager 210 displays the past reply list 22 on the reply selection screen 213.

[Step S34] When the operator selects a message and enters reply data, the ready reply manager 210 sends a ready reply 23 to the inquiry handler 120.

[Step S35] The data storing unit 124 of the server 100 receives the ready reply 23 from the client 200.

[Step S36] The data storing unit 124 stores the ready reply 23 in the ready reply memory 122.

In this way, the operator can register a ready reply easily by using a log of past replies. By using the log, typing error of messages can be prevented.

Further, the operator can change the contents of a ready reply registered. When the operator intends to change a ready reply 23, the operator instructs the ready reply manager 210 to obtain ready replies 23. The ready reply manager 210 sends a ready reply request 41 to the server 100. Upon reception of this request 41, the ready data sender 126 extracts and sends ready replies 23 from the ready reply memory 122 to the client 200 as a ready reply list 42. In the client 200, the ready reply manager 210 receives the list 42 and displays the same on the reply confirmation screen 212.

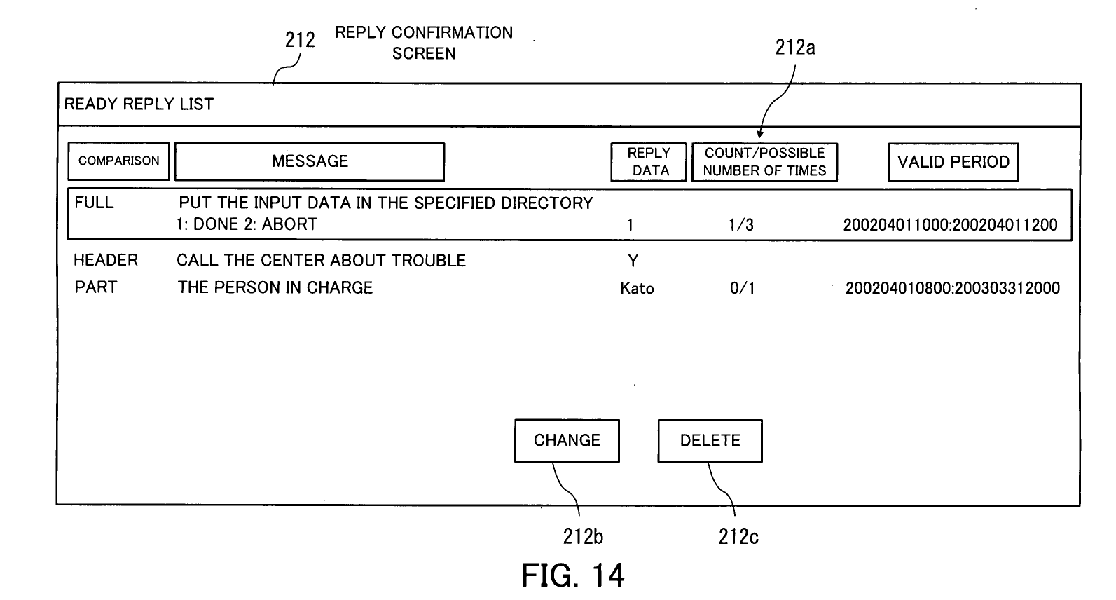

FIG. 14 shows an example of the reply confirmation screen. On this screen 212, a ready reply section 212a, a change button 212b, and a delete button 212c are arranged.

The ready reply section 212a shows all ready replies each including a comparison method, reply message, reply data, count/possible number of times, and valid period. The count/possible number of times indicates how many times the ready reply 23 was used for a response (count) and how many times the ready reply 23 can be used for a response (possible number of times). If the count and possible numbers of times are equal, the corresponding reply data cannot be used until the possible number of times is changed (invalid state). The operator selects a desired ready reply 23 on this ready reply section 212a.

The change button 212b is a button to change the contents of a selected ready reply 23. By pressing this change button 212b, the contents of the selected ready reply 23 are displayed on the reply entry screen 211.

The delete button 212c is a button to delete a selected ready reply 23. By pressing the delete button 212c, a data change request 43 indicating the deletion of the selected ready reply 23 is sent to the server 100, so that the data changing unit 127 deletes (or makes invalid) the corresponding ready reply 23 from the ready reply memory 122.

In a case of changing reply data, the operator selects a desired ready reply 23 from the ready reply section 212a. In an example of FIG. 14, the first ready reply 23 is being selected. When the operator clicks the change button 212b, the reply entry screen 211 appears to change the reply data.

In a case of deleting a ready reply, the operator selects a desired ready reply 23 and clicks the delete button 212c. Thereby the selected ready reply 23 is deleted (made invalid) from the ready reply memory 122.

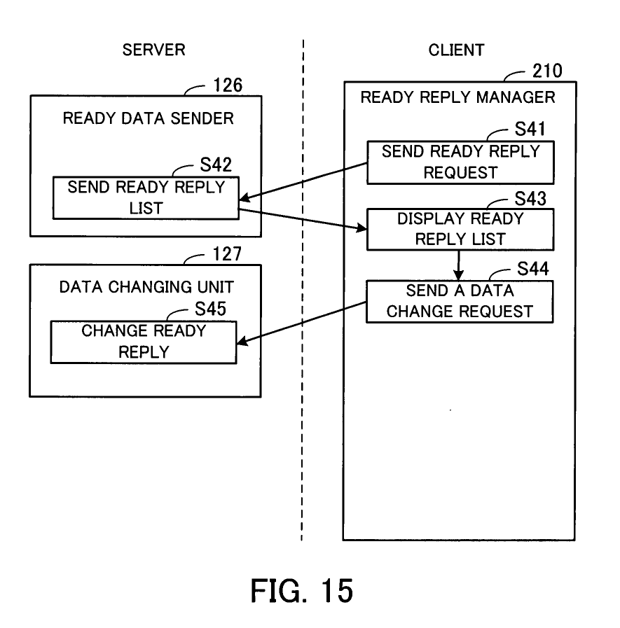

FIG. 15 is a sequence diagram showing a ready reply changing process. This process of FIG. 15 will be described following step numbers.

[Step S41] The ready reply manager 210 sends a ready reply request 41 to the inquiry handler 120 according to operator instruction.

[Step S42] The ready data sender 126 extracts and sends ready replies from the ready reply memory 122 to the ready reply manager 210 as a ready reply list 42.

[Step S43] The ready reply manager 210 displays the ready reply list 42 on the reply confirmation screen 212.

[Step S44] The ready reply manager 210 accepts operator input on the reply confirmation screen 212. When the input indicates change or deletion of a ready reply, the ready reply manager 210 sends a data change request 43 indicating the change or deletion, to the data changing unit 43.

[Step S45] The data changing unit 127 receives the data change request 43. In a case where the change of reply data is specified, the data changing unit 127 changes the contents of the ready reply 23 being stored in the ready reply memory 122. When the deletion of a ready reply is specified, the data changing unit 127 deletes the ready reply 23 from the ready reply memory 122.

According to this embodiment, the operator can register ready replies before the service process issues an inquiry. Therefore, since the operator does not have to wait for the inquiry to be issued, working efficiency can be improved.

Further, the service process can automatically and promptly get a reply registered in advance, the server can perform the service process without stopping, resulting in preventing a delay of processing time due to a late reply from an operator, in turn, improving the processing efficiency of the service process.

Still further, since the operator can set a comparison method of a message for specifying an inquiry, he/she does not necessarily have to know the message of an inquiry to be issued completely to register a ready reply. For example, in a case where an inquiry includes an error code, the operator can make a ready reply to the inquiry by specifying the error code as the reply message of the ready reply and “part match” as a comparison method. This can reduce errors in typing the reply message.

Still further, since a possible number of times for a ready reply can be set, reply data which can be used only the possible number of times can be registered for an inquiry issued many times. When the inquiry is issued a number of times greater than an expected number of times, the operator occasionally makes a response to an inquiry in case system trouble happens. This can keep reliability of a system in which a response is automatically made to an inquiry.

Similarly, since a valid period can be set, reply data that can be used only within the valid period can be registered for an inquiries of which issued time can be expected. In a case where the inquiry is issued over the expected time, the operator occasionally makes a response to the inquiry in case system trouble happens. This can keep reliability of a system in which a response is automatically made to an inquiry.

Still further, using a log of past replies can prevent operators from making typing mistakes.

Still further, a ready reply can be changed or deleted by reference to registered ready replies displayed on a client, thus improving convenience of the ready reply manager.

The above-described processing mechanisms of the present invention are actually implemented on a computer system with a set of computer programs. Encoded in those computer programs are the functions of the inquiry handler 120 of the server 100. The computer system executes such programs to provide the intended functions of the present invention. For the purpose of storage and distribution, the programs are stored in a computer-readable storage medium. Suitable computer-readable storage media include magnetic storage media, optical discs, magneto-optical storage media, and solid state memory devices. Magnetic storage media include hard disk drives (HDD), flexible disks (FD), and magnetic tapes. Optical discs include digital versatile discs (DVD), DVD-random access memory (DVD-RAM), compact disc read-only memory (CD-ROM), CD-recordable (CD-R), CD-rewritable (CD-RW). Magneto-optical storage media include magneto-optical discs (MO). Portable storage media, such as DVD and CD-ROM, are used to distribute program products. Network-based distribution of software program has also become popular, in which master program files stored in a server computer are downloaded to user computers via a network.

Each user computer stores necessary programs in its local storage unit, which have previously been installed from a portable storage media or downloaded from a server computer. The user computer performs intended functions by executing the programs read out of the local storage unit. As an alternative way of program execution, the computer may execute programs, reading out program files directly from a portable storage medium. Another alternative method is that the user computer dynamically downloads programs from a server computer when they are demanded and executes them upon delivery.

As described above, in this invention, when an inquiry is issued, the message of the inquiry is compared with a reply message of a previously stored ready reply. In a case of match, the reply data of the ready reply is sent as a response. As a result, reply data to an inquiry including a prescribed message can be registered in advance.

The foregoing is considered as illustrative only of the principles of the present invention. Further, since numerous modifications and changes will readily occur to those skilled in the art, it is not desired to limit the invention to the exact construction and applications shown and described, and accordingly, all suitable modifications and equivalents may be regarded as falling within the scope of the invention in the appended claims and their equivalents.

1. A program for helping a service process receive responses from an operator, the program causing a computer system to perform a process comprising the steps of:
storing a ready reply in a ready reply memory when receiving the ready reply from a client over a network, the ready reply including two elements: a reply message for specifying an inquiry and reply data to be used as a response;
comparing a message of an inquiry with the reply message of the ready reply being stored in the ready reply memory when the service process issues the inquiry; and
passing the reply data included in the ready reply to the service process when a comparison result shows that the message and the reply message match.

2. The program according to claim 1, wherein the process further comprising the steps of:
storing the inquiry and the reply data as a reply log in a reply log memory when the service process receives the reply data as a response to the inquiry; and
sending a list of the reply log being stored in the reply log memory to the client in response to a reply log delivery request from the client.

3. The program according to claim 1, wherein the process further comprising the steps of:
sending a list of ready replies being stored in the ready reply memory to the client in response to a ready reply delivery request from the client; and
changing a corresponding ready reply in the ready reply memory in response to a ready reply change request from the client.

4. The program according to claim 1, wherein the process further comprising the steps of:
storing a possible number of times together with the ready reply in the ready reply memory when the possible number of times that the ready data can be used as a response is received from the client; and
increasing a response count by one every time when the reply data is used as a response; and
passing the reply data included in the ready reply to the service process when the comparison result shows the message and the reply message match and the response count does not reach the possible number of times.

5. The program according to claim 1, wherein the process further comprising the steps of:
storing a valid period together with the ready reply in the ready reply memory when the valid period of the ready data is received from the client; and
passing the reply data included in the ready reply to the service process when the comparison result shows that the message and the reply message match and the inquiry is issued within the valid period.

6. The program according to claim 1, wherein the message of the inquiry and the reply message are compared under a comparison method when the comparison method is specified by the ready reply.

7. The program according to claim 6, wherein the comparison method is one of full match, header match and part match.

8. A method for helping a service process receive responses from an operator, comprising the steps of:
storing a ready reply in a ready reply memory when a client sends the ready reply over a network, the ready reply including two elements: a reply message for specifying an inquiry and reply data to be used as a response;
comparing a message of an inquiry with the reply message of the ready reply being stored in the ready reply memory when the service process issues the inquiry; and
passing the reply data included in the ready reply to the service process when a comparison result shows that the message and the reply message match.

9. An apparatus for helping a service process receive responses from an operator, comprising:
storing means for storing a ready reply in a ready reply memory when receiving the ready reply from a client over a network, the ready reply including two elements: a reply message for specifying an inquiry and reply data to be used as a response;
a comparison means for comparing a message of an inquiry with the reply message of the ready reply being stored in the ready reply memory when the service process issues the inquiry; and
a notification means for passing the reply data included in the ready reply to the service process when a comparison result shows that the message and the reply message match.

10. A computer-readable recording medium storing a program for helping a service process receive responses from an operator, the program causing a computer system to perform a process comprising the steps of:
storing a ready reply in a ready reply memory when receiving the ready reply from a client over a network, the ready reply including two elements: a reply message for specifying an inquiry and reply data to be used as a response;
comparing a message of an inquiry with the reply message of the ready reply being stored in the ready reply memory when the service process issues the inquiry; and
passing the reply data included in the ready reply to the service process when a comparison result shows that the message and the reply message match.
